(19) United States
(12) Patent Application Publication
(10) Pub. No.: US 2026/0208667 A1
(43) Pub. Date: Jul. 23, 2026

(54) Automatic Turn Signal Activation

(71) Applicant: GM GLOBAL TECHNOLOGY OPERATIONS LLC, Detroit, MI (US)

(72) Inventors: Jeffrey Scott PARKS, Ann Arbor, MI (US); Paul A. ADAM, Milford, MI (US); William Lawrence KOZLOWSKI, Novi, MI (US); Alexander Gene RATH, Fenton, MI (US)

(21) Appl. No.: 19/029,164

(22) Filed: Jan. 17, 2025

(51) Int. Cl. B60Q 1/34

(52) U.S. Cl. CPC B60Q 1/346

(57) ABSTRACT

A vehicle includes first and second turn signal lights to indicate first and second turn directions, and a brake pedal sensor senses a brake pedal position. A steering wheel sensor senses a steering wheel input. An internally-facing camera generates images of a driver. An accelerator pedal sensor senses an accelerator pedal position. A controller constructs a roadway scene for a path of the vehicle, generates a driver intent confidence score for a turning maneuver in response to the steering wheel input and a first gain, a focus of a driver based on the images and a second gain, the brake pedal position and a third gain, and the accelerator pedal position and a fourth gain, compares the driver intent confidence score to a predetermined threshold, and selectively turns on one of the first turn signal light and the second turn signal light in response to the comparison.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles including turn signal lights, and more particularly to a turn signal light control system for automatically activating turn signal lights without requiring a driver operate a turn signal actuator.

Vehicles include a turn signal actuator configured to operate turn signal lights. The driver of the vehicle moves the turn signal actuator in a left (or down) or right (or up) direction prior to a vehicle maneuver to illuminate left or right turn signal lights. The left or right turn signal lights notify other drivers that the driver intends to initiate a turning maneuver and a direction of the turning maneuver. Examples of the turning maneuvers include a left or right turn, a lane change, a merge, and/or other changes to the path of the vehicle. Regular use of turn signals reduces accidents by providing information to other drivers surrounding the vehicle.

### SUMMARY

A vehicle includes a first turn signal light to indicate a first turn direction, a second turn signal light to indicate a second turn direction, and a brake pedal sensor configured to sense a brake pedal position. A steering wheel sensor is configured to sense a steering wheel input. An internally-facing camera is configured to generate images of a driver. An accelerator pedal sensor is configured to sense an accelerator pedal position. A controller is configured to construct a roadway scene for a path of the vehicle, generate a driver intent confidence score for a turning maneuver in response to the steering wheel input and a first gain, a focus of a driver based on the images and a second gain, the brake pedal position and a third gain, and the accelerator pedal position and a fourth gain, compare the driver intent confidence score to a predetermined threshold, and selectively turn on one of the first turn signal light and the second turn signal light in response to the comparison.

In some examples, the predetermined threshold is selected in response to the roadway scene. The driver intent confidence score is based on a sum of a first product of the steering wheel input and the first gain, a second product of the focus of the driver and the second gain, a third product of the brake pedal position and the third gain, and a fourth product of the accelerator pedal position and the fourth gain.

In other features, the controller further includes an image processing module configured to determine the focus of the driver in response to the images from the internally-facing camera. The steering wheel sensor includes a torque sensor configured to sense a steering wheel torque input, and the steering wheel input comprises the steering wheel torque input.

In other features, the controller is configured to evaluate a driver-induced vehicle path. The controller is configured to generate a predicted driver-induced vehicle path. The controller is configured to correlate the predicted driver-induced vehicle path to the roadway scene. The controller is configured to turn off the one of the first turn signal light and the second turn signal light in response to completion of the turning maneuver.

In other features, the controller is configured to turn off the one of the first turn signal light and the second turn signal light in response to a predetermine period expiring before the completion of the turning maneuver.

A method for automatically turning on turn signal indicator lights without driver input includes constructing a roadway scene for a path of a vehicle; generating a driver intent confidence score for a turning maneuver in response to a steering wheel input and a first gain, a focus of a driver and a second gain, a brake pedal position and a third gain, and an accelerator pedal position and a fourth gain; comparing the driver intent confidence score to a predetermined threshold; and selectively turning one of a first turn signal light to indicate a turn in a first direction and a second turn signal light to indicate a turn in a second direction in response to the comparison.

In other features, the predetermined threshold is selected in response to the roadway scene. The driver intent confidence score is a sum of a first product of the steering wheel input and the first gain, a second product of the focus of the driver and the second gain, a third product of the brake pedal position and the third gain, and a fourth product of the accelerator pedal position and the fourth gain.

In other features, the method includes generating images of a face of the driver; and determining the focus of the driver in response to the images.

In other features, the method includes sensing a steering wheel torque input. The steering wheel input comprises the steering wheel torque input. The method includes evaluating a driver-induced vehicle path. The method includes generating a predicted driver-induced vehicle path. The method includes correlating the predicted driver-induced vehicle path to the roadway scene. The method includes turning off the one of the first turn signal light and the second turn signal light in response to completion of the turning maneuver. The method includes turning off the one of the first turn signal light and the second turn signal light in response to a predetermined period expiring before the completion of the turning maneuver.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a functional block diagram of an example of a vehicle including a turn signal light control module configured to automatically activate turn signal lights in response to a driver intent confidence score and a roadway scene according to the present disclosure;

FIGS. 1B to 1E illustrate examples of scenes that may require automatic actuation of turn signal lights;

FIG. 2 is a flowchart of an example of a method for activating turn signals in response to a driver intent confidence score and/or scene indication; and

FIG. 3 is a flowchart of another example of a method for activating turn signals in response to a driver intent confidence score and/or scene indication.

In the drawings, reference numbers may be reused to identify similar and/or identical elements.

### DETAILED DESCRIPTION

The present disclosure relates to automatic control of turn signal lights without driver initiation of a turn signal actuator. A turn signal light control module monitors driver inputs (steering, brake, and/or accelerator), driver eye focus, map data, and/or a roadway scene (e.g., using GPS lane localization and/or adjacent lane detection in response to images from side facing cameras). The turn signal light control module generates a driver intent confidence score and compares the driver intent confidence score to a threshold. If the driver intent confidence score is greater than the threshold, the turn signal light control module turns on a turn signal light.

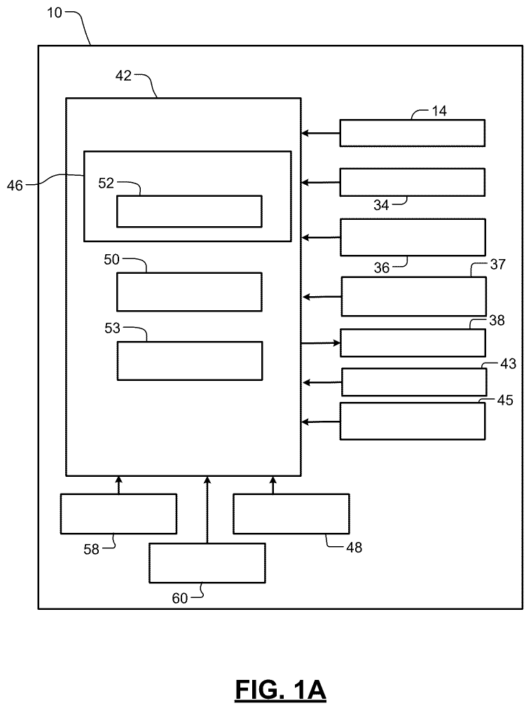

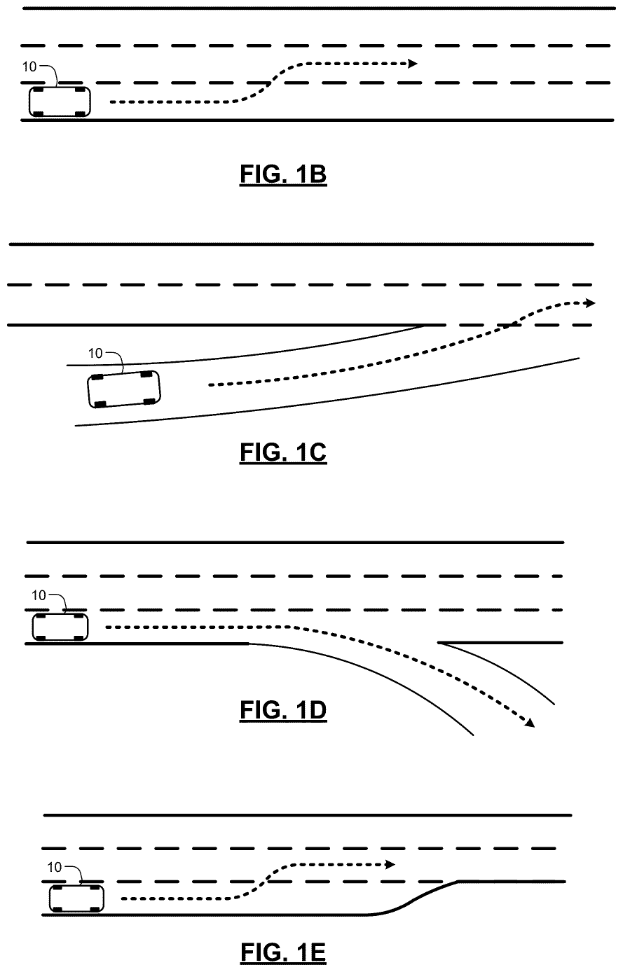

Referring now to FIG. 1A, a vehicle 10 includes a controller 42 including a turn signal light control module 50 that constructs a roadway scene, senses driver inputs (steering angle, brake pedal position, and/or accelerator position), and/or monitors driver eye direction to formulate an understanding of driver intent to perform a turning maneuver such as changing lanes or turning a corner. If the driver's intent is sufficient, the turn signal light control module automatically turns on a left turn signal light or a right turn signal light in a predicted direction of the turning maneuver without requiring the driver to operate the turn signal actuator. Upon detecting completion of the turning maneuver or after a timeout period, the turn signal light control module automatically deactivates the previously actuated turn signal light.

The controller 42 receives an output of a global positioning system (GPS) 14 configured to determine a position of a vehicle. The controller 42 includes a navigation module 46 including map data 52. In some examples, the map data 52 includes high definition (HD) map data that is used to construct a roadway scene. In some examples, the controller 42 includes an image processing module 53 configured to receive images from one or more externally-facing cameras 34 and/or inwardly-facing cameras 36. The image processing module 53 performs image processing on the images to identify lane lines and/or side lanes and/or to determine a direction or focus of eyes of the driver. The GPS 14, the navigation module 46, and/or the image processing module 53 are configured to construct a roadway scene by locating the vehicle 10 relative to one or more lanes of a roadway defined by the map data 52 and to identify possible turning maneuvers in the path of the vehicle.

The map data 52 identifies a current lane of the vehicle as well as intersections, other lanes in the same direction, merging lanes, exits, and/or other roadway features in the path of the vehicle that may involve a turning maneuver. As can be appreciated, some of the roadway features may require the vehicle to initiate a turning maneuver and other roadway features may be optional (such as moving to another lane of a multi-lane road).

Some drivers may not remember to operate a turn signal actuator 37 to illuminate a turn signal light 38 to signal a left or right turn before initiating the turning maneuver. As a result, other nearby vehicles on the roadway are not aware of that the driver intends to make a turning maneuver and may be surprised by the changing direction of the vehicle, which increases the risk of an accident.

The vehicle 10 includes the one or more externally-facing cameras 34 that generate first images in a path of the vehicle 10 and/or second images on opposite sides of the vehicle in left and right side directions (e.g., to capture adjacent lanes). The vehicle 10 may also include the one or more inwardly-facing cameras 36 generating third images including eyes of the driver. The image processing module 53 tracks the focus of the driver's eyes using the third images. Driver focus can be used as an indicator of driver intent since drivers typically look one or more times in a direction of the turning maneuver (and away from a current driving direction of the vehicle) prior to initiating the turning maneuver. In some examples, the image processing module 53 identifies driver focus states such as left mirror, right mirror, rear view mirror, center of road, left side of road, right side of road, over shoulder, instrument panel, etc. that can be correlated with future turning maneuvers.

The vehicle 10 includes a brake pedal sensor 43 configured to sense a position of a brake pedal (not shown). The vehicle 10 includes an accelerator pedal sensor 45 configured to sense a position of the accelerator pedal (not shown). A cruise control system 48 can be used to set a speed of the vehicle 10. The vehicle 10 includes a steering wheel angle sensor 58 to sense a position of the steering wheel (not shown and/or a steering wheel torque sensor 60 to sense a torque of the steering wheel.

Referring now to FIGS. 1B to 1E, non-limiting examples of driving scenes where turning maneuvers may occur are shown. In FIG. 1B, the vehicle 10 is travelling on a multi-lane road in one lane and is attempting to change lanes (to the left or right lane depending on the lane occupied by the vehicle 10). In FIG. 1C, the vehicle 10 is travelling on an on-ramp and needs to merge with one or more lanes of traffic. In FIG. 1D, the vehicle 10 is in a lane of a multi-lane road with an exit or turn. In FIG. 1E, the vehicle 10 is travelling on a multi-lane road and a lane occupied by the vehicle is ending.

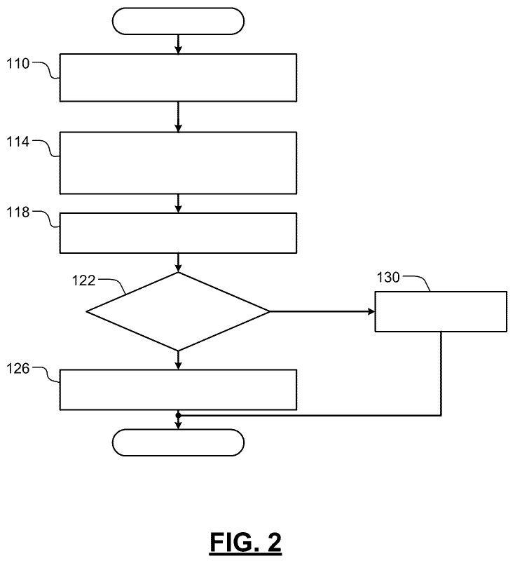

Referring now to FIG. 2, a method for automatically controlling turn signal lights of the vehicle 10 is shown. At 110, the turn signal light control module generates a driver intent confidence score. In some examples, the driver intent confidence score D is calculated as follows:

$$D = K 1 \{ Steering Torque \} + K 2 \{ Driver Focus \} + K 3 \{ Accel Pedal {Pos}^{′} n \} + K 4 \{ Brake Pedal {Pos}^{′} n \}$$

Where K1, K2, K3, and K4 are calibrated gains corresponding to steering torque, driver focus, accelerator pedal position, and brake pedal position, respectively. At 114, a roadway scene is assessed in images taken by the one or more external cameras and/or based on the characteristics of the roadway scene defined by the map to determine whether there are roadway features in the path of the vehicle that may require the vehicle to turn (such as an adjacent lane, exit, merge, split, or intersection).

At 118, the driver intent threshold TH₁ is selected from the turning maneuver or roadway scene that is identified. In some examples, the driver intent threshold TH₁ is the same for all types of turning maneuvers or roadway scenes. In other examples, different driver intent thresholds are used depending upon the predicted maneuver. For example, a lower driver intent threshold may be used when the vehicle is travelling in a lane that is merging or ending soon.

At 122, the method determines whether the driver intent confidence score is greater than the driver intent threshold TH₁. If 122 is false, the turn signal is not activated. If 122 is true, the turn signal is activated.

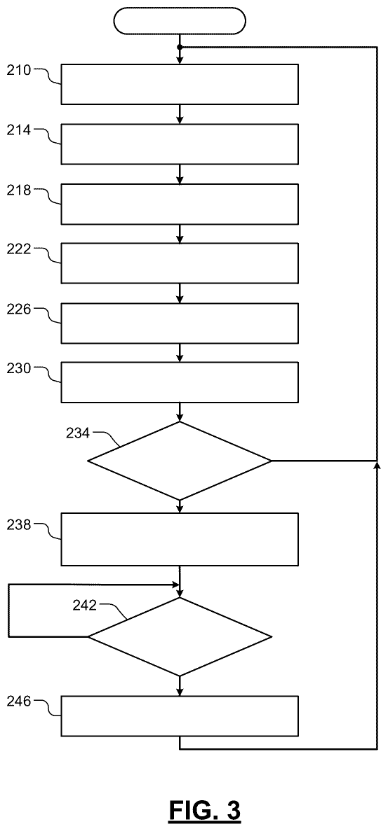

Referring now to FIG. 3, a current scene is constructed from images taken by the cameras and/or from map data at 210. At 214, driver steering wheel input (e.g., steering angle and/or torque) is evaluated. At 218, the driver-induced vehicle path is evaluated. At 222, the driver-induced vehicle path is predicted for the vehicle in the future based on the steering wheel input and the driver-induced vehicle path.

At 226, the predicted driver-induced vehicle path is correlated with or overlayed onto the constructed roadway scene. At 230, a driver intent confidence score is generated. For example, the vehicle is travelling in a right lane that ends soon. Steering wheel input from the driver is in a left direction towards an adjacent lane to the left of the right lane. Driver focus during the prior or current period is in a left direction towards the adjacent lane, a left mirror, and/or the rearview mirror for at least some percentage of a prior or current period. The turn signal light control module evaluates these events and assigns a driver intent confidence score that is compared to the driver intent threshold TH₁.

At 234, the method determines whether the driver intent confidence score is greater than the driver intent threshold for the predicted maneuver. If 234 is false, the method returns to 210. If 234 is true, the method continues at 238 and activates or turns on the turn signal light corresponding to the predicted direction for the turning maneuver and resets a timer. At 242, the method determines whether the turning maneuver is completed and/or a predetermined timeout occurs. If true, the method deactivates the turn signal light at 246 and the method returns to 210.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle comprising:
a first turn signal light to indicate a first turn direction;
a second turn signal light to indicate a second turn direction;
a brake pedal sensor configured to sense a brake pedal position;
a steering wheel sensor configured to sense a steering wheel input;
an internally-facing camera configured to generate images of a driver;
an accelerator pedal sensor configured to sense an accelerator pedal position; and
a controller configured to:
construct a roadway scene for a path of the vehicle;
generate a driver intent confidence score for a turning maneuver in response to the steering wheel input and a first gain, a focus of a driver based on the images and a second gain, the brake pedal position and a third gain, and the accelerator pedal position and a fourth gain;
compare the driver intent confidence score to a predetermined threshold; and
selectively turn on one of the first turn signal light and the second turn signal light in response to the comparison.

2. The vehicle of claim 1, wherein the predetermined threshold is selected in response to the roadway scene.

3. The vehicle of claim 1, wherein the driver intent confidence score is based on a sum of a first product of the steering wheel input and the first gain, a second product of the focus of the driver and the second gain, a third product of the brake pedal position and the third gain, and a fourth product of the accelerator pedal position and the fourth gain.

4. The vehicle of claim 1, wherein the controller further includes an image processing module configured to determine the focus of the driver in response to the images from the internally-facing camera.

5. The vehicle of claim 1, wherein:
the steering wheel sensor includes a torque sensor configured to sense a steering wheel torque input, and
the steering wheel input comprises the steering wheel torque input.

6. The vehicle of claim 1, wherein the controller is configured to evaluate a driver-induced vehicle path.

7. The vehicle of claim 6, wherein the controller is configured to generate a predicted driver-induced vehicle path.

8. The vehicle of claim 7, wherein the controller is configured to correlate the predicted driver-induced vehicle path to the roadway scene.

9. The vehicle of claim 1, wherein the controller is configured to turn off the one of the first turn signal light and the second turn signal light in response to completion of the turning maneuver.

10. The vehicle of claim 9, wherein the controller is configured to turn off the one of the first turn signal light and the second turn signal light in response to a predetermine period expiring before the completion of the turning maneuver.

11. A method for automatically turning on turn signal indicator lights without driver input, comprising:
constructing a roadway scene for a path of a vehicle;
generating a driver intent confidence score for a turning maneuver in response to a steering wheel input and a first gain, a focus of a driver and a second gain, a brake pedal position and a third gain, and an accelerator pedal position and a fourth gain;
comparing the driver intent confidence score to a predetermined threshold; and
selectively turning one of a first turn signal light to indicate a turn in a first direction and a second turn signal light to indicate a turn in a second direction in response to the comparison.

12. The method of claim 11, wherein the predetermined threshold is selected in response to the roadway scene.

13. The method of claim 11, wherein the driver intent confidence score is a sum of a first product of the steering wheel input and the first gain, a second product of the focus of the driver and the second gain, a third product of the brake pedal position and the third gain, and a fourth product of the accelerator pedal position and the fourth gain.

14. The method of claim 11, further comprising:
generating images of a face of the driver; and
determining the focus of the driver in response to the images.

15. The method of claim 11, further comprising:
sensing a steering wheel torque input,
wherein the steering wheel input comprises the steering wheel torque input.

16. The method of claim 11, further comprising evaluating a driver-induced vehicle path.

17. The method of claim 16, further comprising generating a predicted driver-induced vehicle path.

18. The method of claim 17, further comprising correlating the predicted driver-induced vehicle path to the roadway scene.

19. The method of claim 11, further comprising turning off the one of the first turn signal light and the second turn signal light in response to completion of the turning maneuver.

20. The method of claim 19, further comprising turning off the one of the first turn signal light and the second turn signal light in response to a predetermined period expiring before the completion of the turning maneuver.
